(19) United States
(12) Patent Application Publication
(10) Pub. No.: US 2020/0023470 A1
(43) Pub. Date: Jan. 23, 2020

(54) METHOD OF PRODUCING PROJECTION PATH DATA, PROCESSING METHOD, AND CAM SYSTEM

(71) Applicant: DGSHAPE Corporation, Hamamatsu-shi (JP)

(72) Inventors: Makoto YOSHIDA, Hamamatsu-shi (JP); Toshio MAEDA, Hamamatsu-shi (JP); Jun UEDA, Hamamatsu-shi (JP)

(21) Appl. No.: 16/515,324

(22) Filed: Jul. 18, 2019

(30) Foreign Application Priority Data
Jul. 19, 2018 (JP) 2018-135981

(51) Int. Cl. B23K 26/38; B23K 26/03; B23K 26/04; B23K 26/073; B23K 26/08; B23K 26/70

(52) U.S. Cl. CPC B23K 26/38; B23K 26/032; B23K 26/048; B23K 2103/10; B23K 26/0884; B23K 26/702; B23K 26/073

(57) ABSTRACT

A method of producing a projection path data to be used in forming a desired shape by projecting a laser beam into a material, the method includes a first step of converting two-dimensional information representing the desired shape in two dimensions in an XYZ coordinate system into three-dimensional information in an XYZ coordinate system, and a second step of producing the projection path data based on the three-dimensional information that has been converted.

### CROSS REFERENCE TO RELATED APPLICATIONS

This application claims the benefit of priority to Japanese Patent Application No. 2018-135981 filed on Jul. 19, 2018. The entire contents of this application are hereby incorporated herein by reference.

### BACKGROUND OF THE INVENTION

### 1. Field of the Invention

The present invention relates to methods of producing projection path data, processing methods, and CAM systems.

### 2. Description of the Related Art

For example, JP-A-2004-115901 discloses a method of forming an image on a surface of an aluminum alloy, the method including a laser processing step of engraving the surface of the aluminum alloy based on image data, in which, in the laser processing step, shades of images are provided by controlling the depth to engrave the surface using the laser to form irregularities.

According to the image forming method of JP-A-2004-115901, since images are formed on the surface of the material, there is a possibility of deterioration with age or alteration. In addition, since the gradation of the formed picture or figure is insufficient, visibility and expressiveness are poor.

### SUMMARY OF THE INVENTION

Preferred embodiments of the present invention provide novel methods of producing projection path data representing projection path along which a laser beam is projected when a desired shape is formed in a material, processing methods based on such data, and CAM systems that produce such data.

According to a preferred embodiment of the present invention, a method of producing a projection path data to be used in forming a desired shape by projecting a laser beam into a material, includes a first step of converting two-dimensional information representing the desired shape in two dimensions in an XYZ coordinate system into three-dimensional information in an XYZ coordinate system; and a second step of producing the projection path data based on the three-dimensional information that has been converted.

Other features of preferred embodiments of the present invention will be disclosed in the description of the specification.

According to preferred embodiments of the present invention, it is possible to provide novel methods of producing projection path data representing projection path along which a laser beam is projected when a desired shape is formed in a material, and also to provide processing methods based on such data, and CAM systems that produce such data.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a diagram for explaining a method of producing projection path data according to a preferred embodiment of the present invention.

FIG. 1B is a diagram for explaining a method of producing projection path data according to a preferred embodiment of the present invention.

FIG. 1C is a diagram for explaining a method of producing projection path data according to a preferred embodiment of the present invention.

FIG. 1D is a diagram for explaining a method of producing projection path data according to a preferred embodiment of the present invention.

FIG. 1E is a diagram for explaining a method of producing projection path data according to a preferred embodiment of the present invention.

FIG. 1F is a diagram for explaining a method of producing projection path data according to a preferred embodiment of the present invention.

FIG. 1G is a diagram for explaining a method of producing projection path data according to a preferred embodiment of the present invention.

FIG. 2A is a diagram for explaining a method of producing projection path data according to a preferred embodiment of the present invention.

FIG. 2B is a diagram for explaining a method of producing projection path data according to a preferred embodiment of the present invention.

FIG. 2C is a diagram for explaining a method of producing projection path data according to a preferred embodiment of the present invention.

FIG. 2D is a diagram for explaining a method of producing projection path data according to a preferred embodiment of the present invention.

FIG. 2E is a diagram for explaining a method of producing projection path data according to a preferred embodiment of the present invention.

FIG. 2F is a diagram for explaining a method of producing projection path data according to a preferred embodiment of the present invention.

FIG. 3 is a diagram for explaining a method of producing projection path data according to a preferred embodiment of the present invention.

FIG. 4 is a schematic diagram showing a configuration of a processing system and a CAD/CAM system according to a preferred embodiment of the present invention.

FIG. 5 is a flow chart for explaining a processing method according to a preferred embodiment of the present invention.

FIG. 6A is a diagram for explaining a processing method according to a preferred embodiment of the present invention.

FIG. 6B is a diagram for explaining a processing method according to a preferred embodiment of the present invention.

FIG. 6C is a diagram for explaining a processing method according to a preferred embodiment of the present invention.

### DETAILED DESCRIPTION OF THE PREFERRED EMBODIMENTS

Preferred embodiments of the present invention provide a method of producing projection path data to be used when a two-dimensional or three-dimensional shape is created in a material by processing the inside of the material using a laser beam.

For the material according to this preferred embodiment, a light-transmitting material preferably is used. Light-transmitting materials transmit laser beams. Examples of the light-transmitting materials include glass or glass doped with elements, ions, or particles to achieve a desired function or functions. Furthermore, for the light-transmitting material, resins, such as PMMA, having a light transmittance or zirconia-based materials may also be used. Zirconia-based materials may be composite materials such as zirconia-containing glass ceramics or zirconia alone with a certain transmittance. Materials do not require 100% light transmittance and any transmittance value will suffice as long as the laser beam reaches a certain region (process site) for processing.

Laser processing is a method of processing materials by projecting a laser beam. In the laser processing of this preferred embodiment, laser beams for thermal processing or laser pulses for non-thermal processing (ablation) are used.

Thermal processing is a technique that uses laser beam projection on or in the vicinity of the surface of the material for melting a process site. For laser beams for thermal processing, for example, CO₂ lasers can be used.

Non-thermal processing is a method of projecting a laser beam into the material to form, in a process site, a cavity or a portion whose character has been changed. For laser beams for non-thermal processing, the light which is a short-pulsed laser can be used. In particular, it is preferable to use the light which is an ultrashort-pulsed laser to project a laser beam directly to a process site inside a material. An ultrashort-pulsed laser is a laser to emit laser pulses with durations between picoseconds and femtoseconds. Ablation can be performed by exposing a process site inside the material to laser pulses which is an ultrashort-pulsed laser for a short duration. During ablation, the portion of material that is molten using the laser pulses instantaneously evaporates and scatters, thus being eliminated; therefore, damage of each process site due to heat is lower than that using thermal processing. It should be noted that ablation used in this preferred embodiment is a technique of forming a cavity or a portion whose character has been changed in a material, and is technically distinct from thermal processing or other techniques such as 3D laser engraving to create fine scratches (cracks) in the material.

Each projection path data represents a projection path for projecting a laser beam into a material. By projecting the laser beam along the projection path, a desired shape is formed in the material. The desired shape is a two- or three-dimensional representation of a picture or a figure. In place of the picture or the figure, a cleavage site for use in cleaving the material may be formed as the desired shape. The cleavage site is formed by projecting the laser beam along the projection path. By forming the cleavage site, it is possible to cleave the material at the plane (cleavage plane) passing the cleavage site on or in the vicinity of the surface of the material. Each projection path data includes a plurality of point data. Each of the point data has three-dimensional (XYZ) coordinate values.

Furthermore, the projection path data may represent a projection path for projecting a laser beam on or in the vicinity of the surface of the material. In this case, a picture or a figure, which is a desired shape, can be formed on or in the vicinity of the surface of the material.

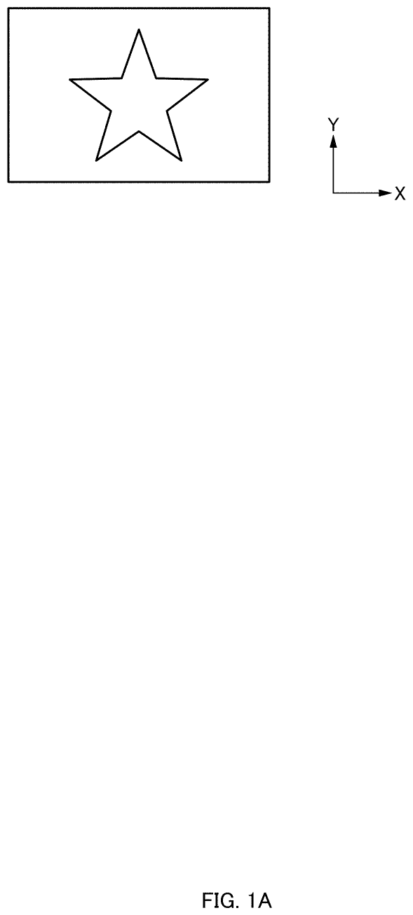

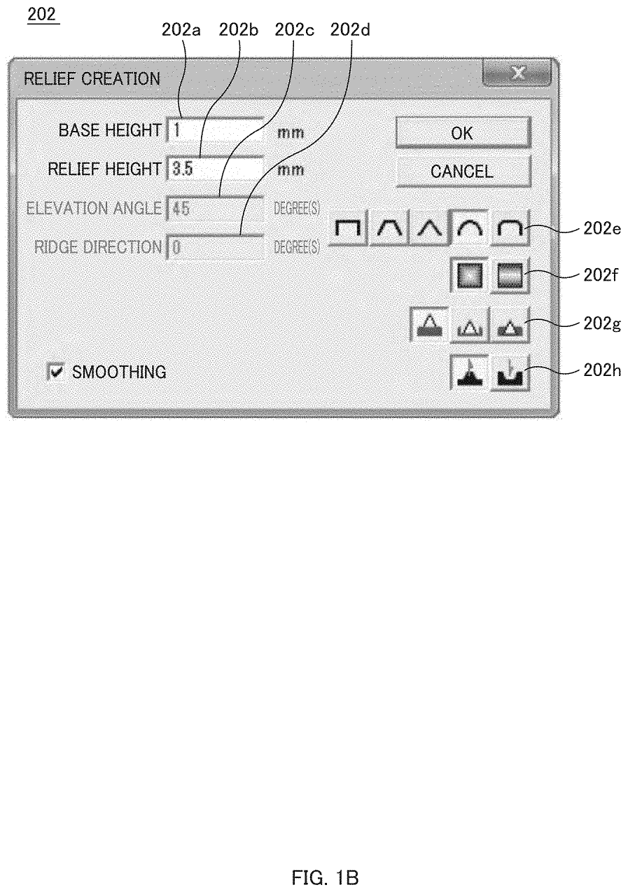

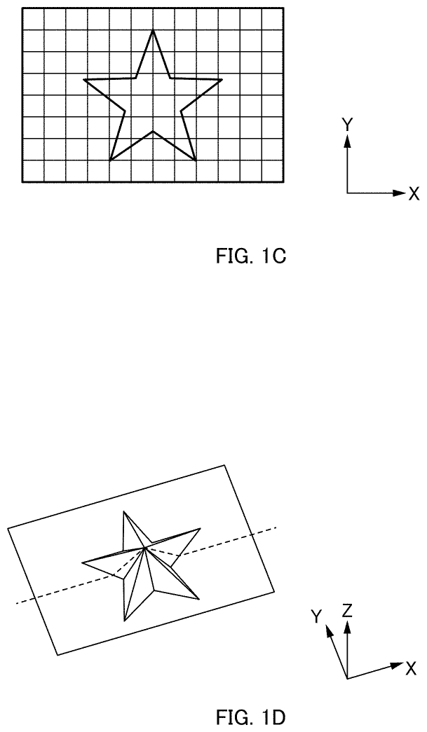

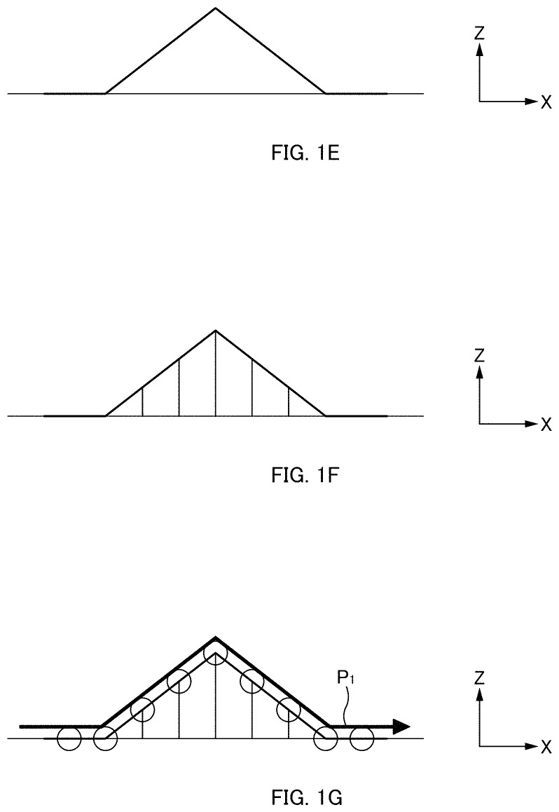

Referring to FIGS. 1A to 3, a method of producing the projection path data according to this preferred embodiment is described. The production of the projection path data is performed by a CAM system (described later). The method of producing the projection path data according to this preferred embodiment includes a first step and a second step.

The first step is a step of converting two-dimensional information representing the desired shape in two dimensions in an XYZ coordinate system into three-dimensional information in an XYZ coordinate system.

The two-dimensional information is information used as the base for a desired shape. For example, the two-dimensional information is a representation of a shape such as a picture or a figure on the two-dimensional plane. The two-dimensional plane is, for example, an XY plane in an XYZ coordinate system. The three-dimensional information is obtained by converting the two-dimensional information by the CAM system. If the two-dimensional plane is assumed to be the XY plane, the three-dimensional information is information with information about a height in the z-direction added to the two-dimensional plane.

The second step is a step of producing the projection path data based on the three-dimensional information that has been converted in the first step.

Next, how to produce the projection path data according to this preferred embodiment is described in detail using three example methods, a first method, a second method, and a third method.

First, the first method is described. FIGS. 1A to 1F are diagrams for explaining a method of producing projection path data according to the first method.

The two-dimensional information used in the first method is, for example, a picture or a figure represented on a certain two-dimensional plane in an XYZ coordinate system. FIG. 1A is a diagram showing two-dimensional information (star shape) represented on an XY plane used in this example. In the first method, the shape formed inside a material is a three-dimensional shape.

In the first method, in the first step, the two-dimensional information is converted into the three-dimensional information by projecting the two-dimensional information onto a three-dimensional mesh including a plurality of grid points, each grid point having three-dimensional coordinates in the XYZ coordinate system.

The three-dimensional information according to this preferred embodiment is represented by a three-dimensional mesh including a plurality of grid points, each grid point having XYZ-coordinates in the XYZ coordinate system. To each grid point of the three-dimensional mesh according to this preferred embodiment, coordinates in an XY plane (i.e., an “x-coordinate” and a “y-coordinate”), and a “z-coordinate” which is height information are set.

In the first method, a way of converting the two-dimensional information into the three-dimensional information is described. FIG. 1B shows an example of a creation dialog box 202 displayed on a display device which the CAM system has. FIG. 1C is a diagram of, seen in the z-direction, the three-dimensional information converted by projecting the two-dimensional information shown in FIG. 1A onto a three-dimensional mesh. FIG. 1D is a perspective view showing three-dimensional information converted by projecting the two-dimensional information onto the three-dimensional mesh. FIG. 1E is a cross-sectional view of the three-dimensional information on an XZ plane along a broken line shown in FIG. 1D.

The CAM system accepts, via the creation dialog box 202, inputs such as some parameters to convert two-dimensional information into desired three-dimensional information.

On the left side of the creation dialog box 202 shown in FIG. 1B, edit boxes used for providing values of parameters to specify a cross-sectional shape of a desired three-dimensional shape are arranged. In the creation dialog box 202, a user specifies a reference z-coordinate of the three-dimensional shape by entering a desired value in the material into an edit box 202a for the “base height.” The base refers to the XY plane that serves as the base level to determine the height information (i.e., z-coordinate) included in the three-dimensional information. In other words, the z-coordinate of the three-dimensional information corresponds to the elevation from the base.

In addition, the user specifies the maximum z-value for the three-dimensional shape by entering a desired value into an edit box 202b for the “relief height”. In other words, the user specifies the width from the z-coordinate of the base to the maximum value of the z-coordinate of the three-dimensional information.

An edit box 202c for the “elevation angle” is used when the user selects a triangular or trapezoidal cross-sectional shape using a button 202e located at the top on the right side of the creation dialog box 202. The user can specify an elevation angle from the base of the selected cross section by entering a desired value into the edit box 202c.

An edit box 202d for the “ridge direction” is used when the user selects a triangular cross-sectional shape. The user can freely modify the interior angle by entering a desired value into the edit box 202d.

On the right side of the creation dialog box 202 shown in FIG. 1B, buttons are arranged which are used to specify the cross-sectional shape of the three-dimensional shape formed in a material. Five buttons 202e are aligned at the top. These buttons are for specifying a cross section of a three-dimensional shape on a plane (such as the XZ plane) perpendicular to the XY plane. In this example, from the left, the arranged buttons 202e are for choosing rectangular, trapezoidal, triangular, arc-shaped, and fillet-shaped cross-sections. The user selects one of these cross-sectional shapes and applies it as the cross-sectional shape of the desired three-dimensional shape.

Two buttons 202f are aligned below the buttons 202e. These buttons are for determining whether the cross-sectional shape on the XZ plane selected using one of the buttons 202e is applied to other cross section (YZ cross section). When the user selects the left button, the cross-sectional shape selected using one of the buttons 202e is also applied to the XY and XZ cross-sectional shapes of the desired three-dimensional shape. When the user selects the right button, the cross-sectional shape selected using one of the buttons 202e at the top is applied only to the XZ cross-sectional shape of the desired three-dimensional shape and another desired cross-sectional shape (such as rectangular) is applied to the YZ cross-sectional shape.

Three buttons 202g are aligned below the buttons 202f. These buttons are for defining the relation between a pedestal and the desired three-dimensional shape. The pedestal is a three-dimensional shape formed inside the material and is formed based on pedestal information. The pedestal information is represented by a three-dimensional mesh. Each grid point of the three-dimensional mesh associated with the pedestal information is assigned with x- and y-coordinates as well as a z-coordinate which is height information of the pedestal. The pedestal has a convex shape in the z-direction.

Among the three buttons 202g, when the user selects the left button, it is defined such that a three-dimensional shape having the cross-sectional shape selected using the button 202e is elevated from the top of the pedestal in the material.

Two buttons 202h are aligned below the buttons 202g. These buttons are for defining the direction in which the cross-sectional shape selected using the button 202e extends, curving outward. When the user selects the left button, the cross-sectional shape selected using the button 202e is defined such that it extends up in the z-direction. When the user selects the right button, the cross-sectional shape is defined such that it extends down in the z-direction.

As described above, when the parameters and others are specified via the creation dialog box 202, the CAM system converts two-dimensional information into three-dimensional information based on the parameters and others. That is, the CAM system determines the cross-sectional shape of the desired three-dimensional shape based on the parameters and others specified via the creation dialog box 202. Then, the CAM system converts two-dimensional information into three-dimensional information by assigning the height in the z-direction to each grid point based on the determined cross-sectional shape (FIGS. 1C to 1E).

It should be noted that the first step in the first method can be applied to cases in which a desired shape is formed on the surface of the material rather than the inside thereof. In such cases, in order to convert two-dimensional information into three-dimensional information, the z-coordinate of each grid point of the three-dimensional mesh constituting the three-dimensional information may be taken as the z-coordinate on the surface of the material.

Next, in the second step, projection path data is produced based on the three-dimensional information converted in the first step.

Specifically, in the second step, first, based on the z-coordinate in the XZ cross section of the shape represented by the three-dimensional information converted in the first step, the height in the z-direction of each grid point is determined (FIG. 1F).

Next, the heights of the grid points determined in the previous step are offset according to the spot diameter of the laser beam. In other words, the height of each grid point determined in the previous step is sifted up along the z-axis by a distance which is half the spot diameter of the laser beam used in the laser processing step described later.

Then, projection path data is produced according to the heights of the grid points that have been offset. First, a path connecting the grid points after the offset is defined as projection path P₁ (FIG. 1G). As described above, the projection path data is including a plurality of point data. Each of the plurality of point data has three-dimensional (XYZ) coordinate values. The three-dimensional coordinate values are coordinates on the projection path P₁. The three-dimensional coordinate values are set at predetermined intervals from the adjacent three-dimensional coordinate values in consideration of the size of the material, the desired three-dimensional shape, and the like. Through the aforementioned procedure, the projection path data according to the first method is produced.

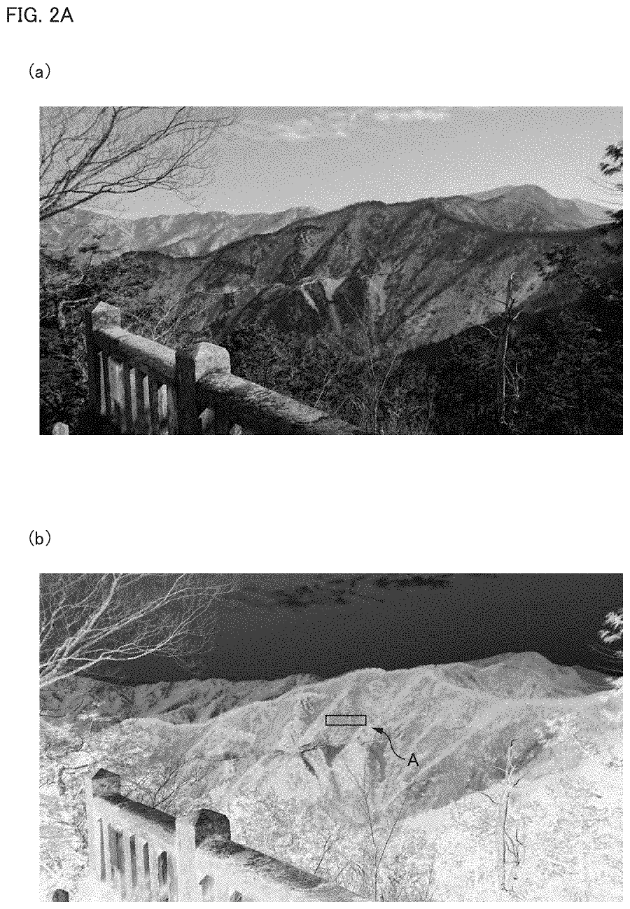

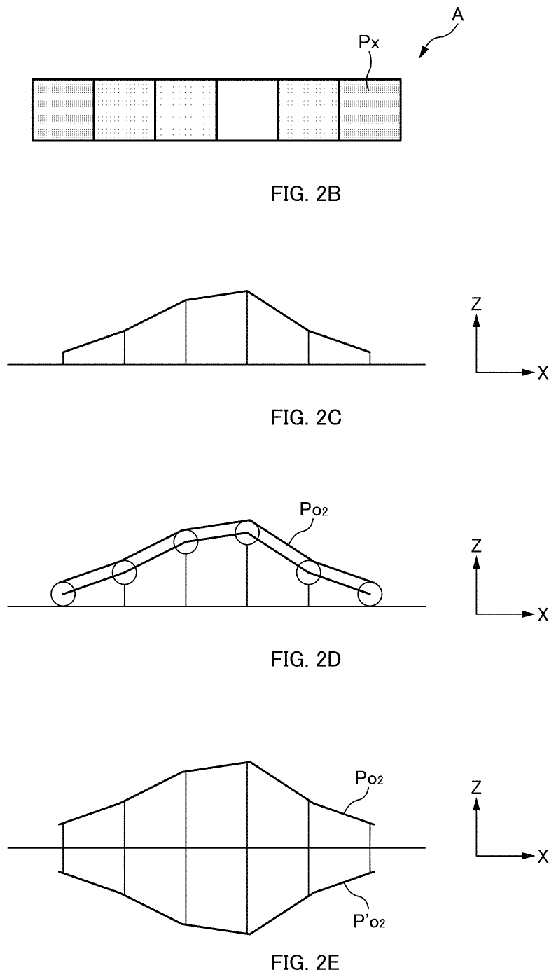

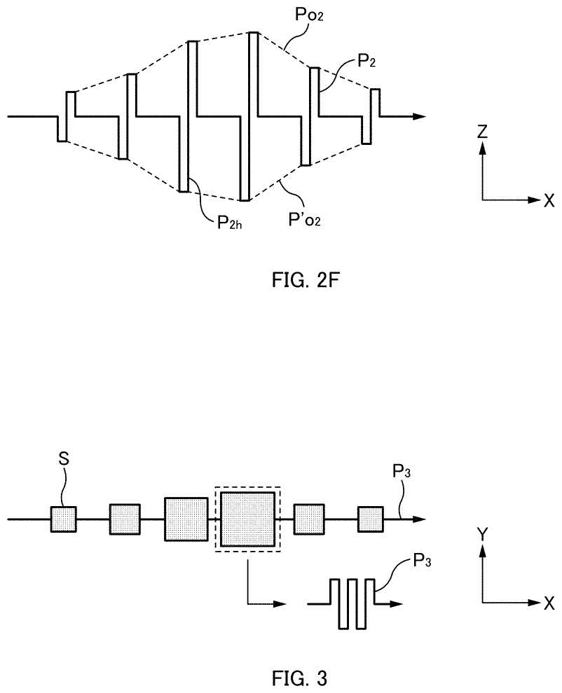

Next, the second method is described. FIGS. 2A to 2F are diagrams for explaining a method of producing projection path data according to the second method.

FIG. 2A(a) shows a two-dimensional image (photograph) which is the two-dimensional information used in this example. The two-dimensional image is including a plurality of pixels arranged in a matrix, and has luminance information for each pixel. The luminance information includes shades depending on gradation.

In the first step, first, a two-dimensional image is created by inverting colors of a two-dimensional image (FIG. 2A(b)). Then, the two-dimensional image of which color has been inverted is converted into three-dimensional information by projecting, onto a three-dimensional mesh including a plurality of grid points each having three-dimensional coordinates in the XYZ coordinate system. In the second method, each grid point of the three-dimensional mesh is assigned with luminance information of a pixel Pₓ corresponding to the grid point. The converted three-dimensional information is loaded into the CAM system. The CAM system produces projection path data based on the three-dimensional information in a second step described later.

FIG. 2B shows six pixels Pₓ corresponding to an area A in FIG. 2A(b). In FIG. 2B, each pixel Pₓ shows a shade depending on gradation.

In the second step, a height in the z-direction at each grid point is determined based on the luminance information assigned to each grid point in the first step (FIG. 2C). The height determined based on the luminance information is a height that is proportional of the gradation of the pixel Pₓ assigned to each grid point. In this case, in the two-dimensional image after the color inversion, the higher (lower) the luminance of the pixel Pₓ corresponding to each grid point is, the higher (lower) the height in the z-direction at the grid point.

Next, the heights of the grid points that have been determined are offset depending on a spot size of the laser beam (FIG. 2D). In other words, the height of each grid point determined in the previous step is moved up along the z-axis by a distance which is half the spot diameter of the laser beam. In this way, a path connecting the grid points that have been offset is produced, and this path is defined as an original path P_{O2}.

Then, projection path data is produced based on the height of each grid point that has been offset. FIG. 2E shows the original path P_{O2} produced in the previous step and a path P_{O2}, obtained by flipping the original path P_{O2} relative to the base (as in the first method, this means the XY plane as the reference for the z-coordinate included in the three-dimensional information). A projection path P₂ in this example includes a height portion P₂ₕ (FIG. 2F). The height portion P₂ₕ is a path that is provided at each grid point and extends from the z-coordinate of the original path P_{O2} at each grid point to the z-coordinate of the flipped original path P_{O2′}. The projection path P₂ is obtained by connecting the height portions P₂ₕ at adjacent grid points. When the projection path P₂ is produced through the aforementioned procedure, projection path data including a plurality of point data can be produced in the same manner as in the first method. It should be noted that the projection path data may not be a plurality of point data. For example, it may be one-dimensional, two-dimensional or three-dimensional region data that specifies a range to which the laser beam is to be projected to the material. In the case of the second method, the one-dimensional region data may be data representing the height portion P₂ₕ at each grid point in the projection path P₂.

A plurality of line segments extending from each point on the original path P_{O2} downward in the z-direction and perpendicular to the base may be defined as the height portion P₂ₕ at each grid point.

Next, the third method is described. Similar to the second method, also in the description of the third method, a two-dimensional image having luminance information for each pixel Pₓ is used as the two-dimensional information.

In the third method, the steps to the offset of the height in the z-direction at the grid points according to the spot size of the laser beam (FIGS. 2A to 2D) are shared with the second method, so a detailed description thereof is omitted.

FIG. 3 is a diagram for explaining a method of producing projection path data according to the third method. A projection path P₃ in the third method includes a plurality of light-shielding regions S (FIG. 3). Each of the plurality of light-shielding regions S is disposed at each grid point. As described in the second method, each grid point is assigned with luminance information of the corresponding pixel P. In the third method, an area of a light-shielding region S disposed at each grid point is determined based on the luminance information assigned to each grid point. The light-shielding region S is a two-dimensional region parallel to the XY plane. The shape of the light-shielding region S is not particularly limited and it is a square in this example.

The area of the light-shielding region S is determined according to the height of the grid point that has been offset (FIG. 2D). The area of the light-shielding region S is, for example, an area proportional to the height of the grid point after the offset. In this case, in the two-dimensional image after the color inversion, the higher (lower) the luminance of the pixel Pₓ corresponding to each grid point is, the larger (smaller) the area of the light-shielding region S at the grid point is.

Next, projection path data is produced depending on the area of the light-shielding region S that has been determined. First, a projection path is defined in each light-shielding region S. In the example shown in FIG. 3, the projection path is defined such that, in the light-shielding region S, that one light-shielding region S is scanned at certain intervals. Then, by connecting the projection paths in the adjacent light-shielding regions S, the entire projection path P₃ is defined. When the projection path P₃ is produced through the aforementioned procedure, projection path data including a plurality of point data can be produced in the same manner as in the first method. The projection path data may not be a plurality of point data. For example, it may be one-dimensional, two-dimensional or three-dimensional region data that specifies a range to which the laser beam is to be projected to the material. In the case of the third method, the one-dimensional region data may be data representing a line segment connecting adjacent light-shielding regions S. Further, the two-dimensional region data may be data representing a region occupied by the light-shielding region S.

In the third method, based on the luminance information, the steps from determining the z-directional height at each grid point to offsetting the height of the grid point (FIGS. 2C and 2D) can be omitted.

Specifically, an area of a light-shielding region for each pixel Pₓ may be determined, by inverting a color of a two-dimensional image representing the desired shape in two dimensions in an XYZ coordinate system (FIG. 2A(b)), based on the luminance information of each pixel Pₓ of the two-dimensional image. In this case, the area of the light-shielding region S is, for example, an area proportional to the gradation after color inversion assigned to each grid point. That is, in the two-dimensional image after the color inversion, the higher (lower) the luminance of the pixel Pₓ corresponding to each grid point is, the larger (smaller) the area of the light-shielding region S at the grid point is. Then, the projection path is defined depending on the area of the light-shielding region S that has been determined.

In the above, the methods of producing projection path data in the first, second, and third methods are described. The focal position of the laser beam varies depending on the refractive index of the material. Therefore, the projection path data may be corrected in consideration of the refractive index of the material. Specifically, a numerical value obtained by dividing the height from the coordinates represented by the projection path data before correction to the surface of the material by the refractive index is defined as the height from the coordinates represented by the projection path data after the correction to the surface of the material.

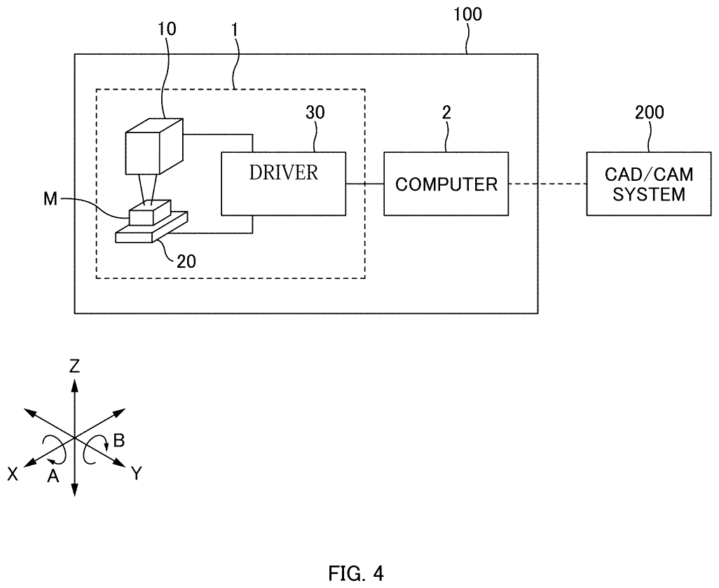

FIG. 4 is a diagram schematically showing a processing system 100 and a CAD/CAM system 200. The processing system 100 includes a processor 1 and a computer 2. The processing system 100, however, can be formed by a processor 1 alone when the functions of the computer 2 are integrated into the processor 1.

The processor 1 according to this preferred embodiment has five driving axes (the x-, y-, and z-axes as well as the A-rotation axis (the rotation axis around the x-axis) and B-rotation axis (the rotation axis around the y-axis)). The processor 1 is configured or programmed to process a material M, based on the projection path data, by projecting laser beams along the projection paths. The processor 1 is configured or programmed to include a projector 10, a holder 20, and a driver 30.

The projector 10 projects laser beams to the material M. The projector 10 includes a laser oscillator and an optical system including a group of lenses and a galvanometer mirror to direct the laser beam produced by the oscillator to the material M. The holder 20 holds a material M. Any method can be used for holding the material M. The driver 30 includes a drive motor and other components. The driver 30 moves the projector 10 and the holder relative to each other, provided that, according to the processing method in this preferred embodiment, the desired shape can be formed by projecting the laser beam from one direction. That is, it is unnecessary to rotate the projector 10 and the holder 20 on the A- or B-rotation axis.

It should be noted that an adjuster that adjusts projection patterns of the laser may be provided. The adjuster is a member such as a galvanometer mirror, a Fresnel lens, a diffractive optical element (DOE), or a spatial light phase modulator (LCOS-SLM). The adjuster is disposed, for example, between the oscillator and the group of lenses in the projector 10.

For example, in the case that the projection path includes a linear path, it is possible to project laser beams at once to the linear path among the all projection paths by using a spatial light phase modulator as the adjuster. In addition, in the case that the projection path includes a planar path, by using the spatial light phase modulator as the adjuster, it is possible to project the laser beams at once to the planar path among the all projection paths. Spatial light phase modulators can adjust the laser beam produced by an oscillator into a desired shape by adjusting the liquid crystal orientation. For example, a spatial light phase modulator can project a linear laser beam (a laser beam with a one-dimensional shape) or a plane-shaped laser beam (a laser beam with a two-dimensional shape) by shaping the focal point of a beam from a point laser into a line or a plane. By using such a spatial light phase modulator, for example, ablation can be performed using a single projection to a projection path based on one line segment or a projection path based on one plane among the all projection paths. That is, by using the spatial light phase modulator, it is possible to process the projection paths in a one-dimensional or two-dimensional region at once, reducing the processing time.

The computer 2 controls operations of the projector 10 and the driver 30. Specifically, the computer 2 controls the driver 30 to adjust the relative position between the projector 10 and the holder 20 (the material M) such that the laser beam can be projected to the projection path represented by the projection path data in the material M. When the laser beam enters the material M, the focal position of the laser beam varies depending on the refractive index of the material M. By considering the contribution of the refractive index of the material M, the computer 2 may correct the relative position between the projector 10 and the holder 20. In this case, during the production of the projection path data, the refractive index of the material M may not be taken into consideration. Furthermore, the computer 2 controls the projector 10 to adjust the focal position of each laser beam as well as the spot diameter and intensity of the projected laser beam and to project a laser beam to the material M for a certain amount of time. The spot diameter, intensity, and projection time affect the power (energy) of the projected laser beam. These parameters may be included beforehand in the projection path data or may be set in the processor 1. For determining these values, the type and/or the property of the material M to be processed can be considered. The computer 2 is an example of the “controller.”

When the projection path data is for forming a cleavage site, the computer 2 may control the projector 10 to use laser beams for thermal processing. In the case that a laser beam for thermal processing is used, the laser beam is projected in ascending order of distance from a surface through which the laser beam is directed to the positions corresponding to the point data of the projection path data. This order may be included in the projection path data beforehand or may be set by the processor 1.

The CAD/CAM system 200 produces the projection path data and supplies it to the processing system 100. The CAD/CAM system 200 in this preferred embodiment is an example of the “CAM system.” Unlike this preferred embodiment, a CAD system and a CAM system may be provided separately.

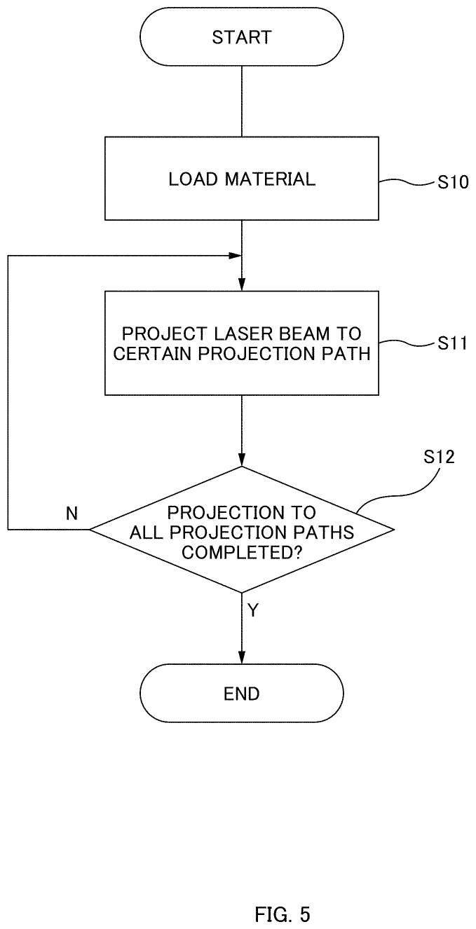

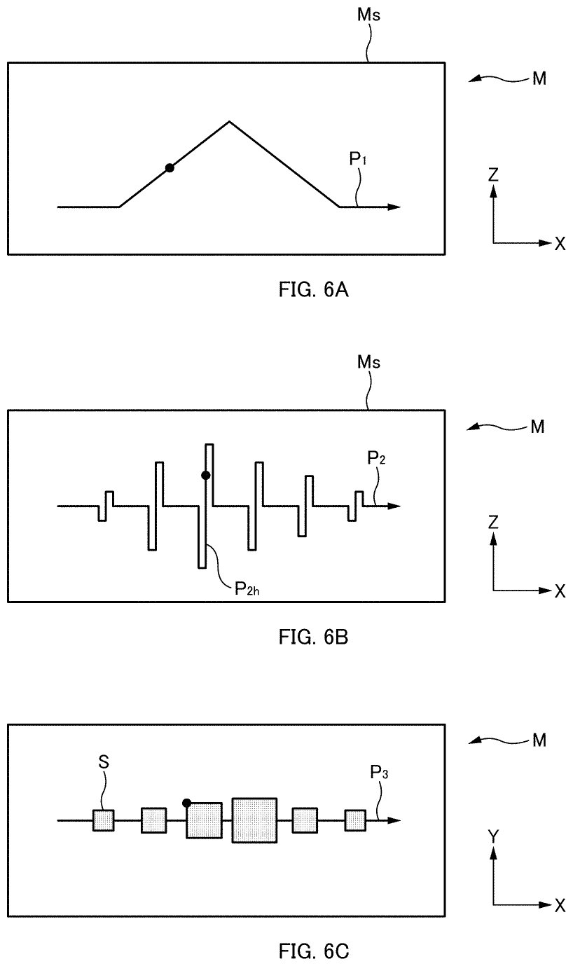

Next, referring to FIGS. 5 and 6A to 6C, a specific example of the processing method according to this preferred embodiment is described. The processing method is performed by the processing system 100. In addition, the processing method, as a dedicated processing program, has been installed beforehand on the processing system 100. FIG. 5 is a flow chart showing a sequence of operations of the processing system 100. FIGS. 6A to 6C are diagrams schematically showing a projection path along which the laser beam is projected by the processing method according to this preferred embodiment. FIGS. 6A, 6B, and 6C are diagrams for explaining processing using the projection path data produced by the aforementioned first, second, and third methods, respectively. The projection path data is assumed to have been produced beforehand by the CAD/CAM system 200.

The material M is selected and loaded into the holder 20 of the processor 1 (load the material; step 10). The material M of this preferred embodiment is a block-shaped member.

The computer 2 makes the processor 1 project a laser beam based on the projection path data. The computer 2 processes inside the material by causing laser beams to be projected to positions corresponding to the three-dimensional coordinates represented by the projection path data. In this case, the computer 2 projects laser beams to these positions in certain order (projection of laser beams to a certain projection path; step 11).

The computer 2 makes an adjustment such that the three-dimensional coordinate values included in the projection path data match the focal position of the laser beam. Specifically, the computer 2 adjusts the relative position between the projector 10 and the holder 20 and adjusts the orientation of the outcoming light from the group of lenses and the angle of the galvanometer mirror included in the projector 10. After the coordinate values of the point data match the focal position of the laser beam, the computer 2 controls the projector 10 and makes it project a laser beam from the top along the z-axis for a certain amount of time.

The laser beam is projected such that its focal position scans the XY plane regardless of which one of the projection path data produced by the first, second, and third methods is used. In the example shown in FIGS. 6A to 6C, the focal position of the laser beam is reciprocated in the x-direction while being shifted in the y-direction at a predetermined scanning pitch in the XY plane.

In the case of the first method, the laser beam is projected to a certain position represented by the projection path data for a certain amount of time while moving the focal position of the laser beam in the x-direction and moving it in the z-direction according to the projection path P₁ (FIG. 6A). When the projection of the laser beam is completed over the x-direction, the focal position of the laser beam is shifted in the y-direction at a predetermined scanning pitch, and the projection of the laser beam is repeated in the same manner.

In the case of the second method, the laser beam is projected to a certain position represented by the projection path data for a certain amount of time while moving the focal position of the laser beam in the x-direction and moving it in the z-direction according to the projection path P₂ (FIG. 6B). In this case, the projection path data is produced such that the focal position of the laser beam moves from the bottom up along the height portion P₂ₕ of the projection path P₂. When the projection of the laser beam is completed over the x-direction, the focal position of the laser beam is shifted in the y-direction at a predetermined scanning pitch, and the projection of the laser beam is repeated in the same manner.

In the case of the third method, when reached to the light-shielding region S while moving the focal position of the laser beam in the x-direction, the laser beam is projected while moving it to scan over the light-shielding region S (FIG. 6C). When the projection of the laser beam is completed over the x-direction, the focal position of the laser beam is shifted in the y-direction at a predetermined scanning pitch, and the projection of the laser beam is repeated in the same manner. In the third method, a cavity or a portion whose character has been changed may be formed over the light-shielding region S, and preferred embodiments of the present invention are not limited to the laser projection to scan the light-shielding region S. For example, in one light-shielding region S, the focal points of laser beams may be shaped into the shape of that light-shielding region S to project these laser beams at once.

When the projection of the laser beam is completed to all of the projection paths (Y at step 12), formation of a desired shape is completed, and the process is ended.

Here, the material M having the desired shape formed therein based on the second method and the third method is placed above the paper surface etc. at a distance from the paper surface etc., with surface Ms (the surface through which the laser beam passes during processing) facing up. Then, when light is projected to the material M from above (when the light is caused to enter from the surface Ms), a desired shape formed inside the material M appears on the paper surface. This is because a cavity or a portion whose character has been changed is formed along the projection path as a result of the laser beam projected over the projection path, and the cavity or the portion whose character has been changed has a light shielding property.

For example, in the second method, the higher (lower) the luminance of each pixel Pₓ of the two-dimensional image before color inversion is, the lower (higher) the z-directional height of the projection path at the position corresponding to the pixel is, and the lower (higher) the light-shielding property of the position corresponding to the pixel is. Further, in the third method, the higher (lower) the luminance of each pixel Pₓ of the two-dimensional image before color inversion is, the smaller (larger) the area of the light-shielding region S at the position corresponding to the pixel is, and the lower (higher) the light-shielding property at the position corresponding to the pixel is. Therefore, by projecting the light to the material M as described above, shades of the two-dimensional image before the color inversion appear on the paper.

As described above, the method of producing the projection path data according to this preferred embodiment is a method of producing a projection path data to be used in projecting a laser beam into a material and forming a desired shape, the method including: a first step of converting two-dimensional information representing the desired shape in two dimensions in an XYZ coordinate system into three-dimensional information in an XYZ coordinate system; and a second step of producing the projection path data based on the three-dimensional information that has been converted.

Thus, in the method according to this preferred embodiment, it is possible to produce projection path data for forming a desired shape (two-dimensional or three-dimensional) inside the material. The shape formed inside the material based on such projection path data is not likely to deteriorate with age or to be altered. Further, since the projection path data is produced based on three-dimensional information, the shape formed inside the material is superior in visibility and expressiveness.

In addition, in the method of producing the projection path data according to this preferred embodiment, in the first step, the two-dimensional information is converted into the three-dimensional information by projecting the two-dimensional information onto a three-dimensional mesh including a plurality of grid points, each grid point comprising three-dimensional coordinates in the XYZ coordinate system; and in the second step, a z-directional height of each grid point, the height being determined based on a z-coordinate, in an XYZ coordinate system, of a shape represented by the three-dimensional information that has been converted is offset depending on a spot diameter of the laser beam; and the projection path data is produced based on the height of each grid point that has been offset. By using such a method, two-dimensional information can be expressed as three-dimensional information on a three-dimensional mesh. Therefore, the shape (in particular, the surface shape) formed inside the material is superior in visibility and expressiveness.

Furthermore, in the method of producing the projection path data according to this preferred embodiment, the two-dimensional information is a two-dimensional image including luminance information for each pixel Pₓ; and in which in the first step, the two-dimensional image is converted into the three-dimensional information by projecting, onto a three-dimensional mesh including a plurality of grid points, the two-dimensional image of which color has been inverted, each grid point including three-dimensional coordinates in the XYZ coordinate system; and in the second step, a z-directional height of each grid point is determined based on the luminance information; the height of the grid point that has been determined is offset depending on a spot size of the laser beam; and the projection path data is produced based on the height of each grid point that has been offset. In this case, the gradation at each grid point is expressed by the projection path according to the height of the grid point. By projecting a laser beam along such a projection path, a wide range of gradations can be expressed inside the material. Therefore, the shape formed inside the material is superior in visibility and expressiveness.

Furthermore, in the method of producing the projection path data according to this preferred embodiment, the two-dimensional information is a two-dimensional image including luminance information for each pixel Pₓ; and in which in the first step, the two-dimensional image is converted into the three-dimensional information by projecting, onto a three-dimensional mesh including a plurality of grid points, the two-dimensional image of which color has been inverted, each grid point including three-dimensional coordinates in the XYZ coordinate system; and in the second step, a z-directional height of each grid point is determined based on the luminance information; the height of the grid point that has been determined is offset depending on a spot size of the laser beam; an area of a light-shielding region S is determined based on the height of each grid point that has been offset; and the projection path data is produced depending on the area of the light-shielding region S that has been determined. In this case, the light-shielding region S having an area based on luminance information is formed at each grid point. By projecting a laser beam to such a light-shielding region S, a wide range of gradations can be expressed inside the material. Therefore, the shape formed inside the material is superior in visibility and expressiveness.

Moreover, in a method of producing the projection path data according to this preferred embodiment, the method to be used in projecting a laser beam into a material and forming a desired shape may include inverting a color of a two-dimensional image representing the desired shape in two dimensions in an XYZ coordinate system, determining an area of a light-shielding region S for each pixel Pₓ based on luminance information of each pixel Pₓ of the two-dimensional image; and determining the projection path depending on the area of the light-shielding region S that has been determined. By projecting a laser beam to such a light-shielding region S, a wide range of gradations can be expressed inside the material. Therefore, the shape formed inside the material is superior in visibility and expressiveness. Furthermore, the production of the projection path can be simplified.

Furthermore, in a method of processing inside the material according to this preferred embodiment, it is possible to forming a desired shape in a material by projecting a laser beam along a projection path represented by a projection path data produced by a production method according to any one of the methods of producing projection path data mentioned above. The shape formed inside the material by such a processing method is not likely to deteriorate with age or to be altered. Further, since the projection path data is produced based on three-dimensional information, the shape formed inside the material is superior in visibility and expressiveness.

The CAM system according to this preferred embodiment is a CAM system that produces a projection path data to be used in projecting a laser beam into a material and forming a desired shape, in which the projection path data is produced by executing a first processing of converting two-dimensional information representing the desired shape in two dimensions in an XYZ coordinate system into three-dimensional information in an XYZ coordinate system, and a second processing of producing the projection path data based on the three-dimensional information that has been converted. As described above, by using to the CAM system according to this preferred embodiment, projection path data for forming a desired shape (two-dimensional or three-dimensional) inside the material can be produced. The shape formed inside the material based on such projection path data is not likely to deteriorate with age or to be altered. Further, since the projection path data is produced based on three-dimensional information, the shape formed inside the material is superior in visibility and expressiveness.

It is also possible to supply a program to a computer using a non-transitory computer readable medium with an executable program thereon, in which the program in the above preferred embodiment is stored. Examples of the non-transitory computer readable medium include magnetic storage media (e.g. flexible disks, magnetic tapes, and hard disk drives), and CD-ROMs (read only memories).

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method of producing a projection path data to be used in forming a desired shape by projecting a laser beam into a material, the method comprising:
a first step of converting two-dimensional information representing the desired shape in two dimensions in an XYZ coordinate system into three-dimensional information in an XYZ coordinate system; and
a second step of producing the projection path data based on the three-dimensional information that has been converted.

2. The method according to claim 1, wherein
in the first step, the two-dimensional information is converted into the three-dimensional information by projecting the two-dimensional information onto a three-dimensional mesh including a plurality of grid points each including three-dimensional coordinates in the XYZ coordinate system; and
in the second step, a z-directional height of each of the plurality of grid points, the height being determined based on a z-coordinate of a shape represented by the three-dimensional information that has been converted is offset depending on a spot diameter of the laser beam; and
the projection path data is produced based on the height of each of the plurality of grid points that has been offset.

3. The method according to claim 1, wherein
the two-dimensional information is a two-dimensional image including luminance information for each pixel;
in the first step, the two-dimensional image is converted into the three-dimensional information by projecting, onto a three-dimensional mesh including a plurality of grid points, the two-dimensional image of which color has been inverted, each of the plurality of grid points including three-dimensional coordinates in the XYZ coordinate system; and
in the second step, a z-directional height of each of the plurality of grid points is determined based on the luminance information;
the height of one of the plurality of grid points that has been determined is offset depending on a spot size of the laser beam; and
the projection path data is produced based on the height of each of the plurality of grid points that has been offset.

4. The method according to claim 1, wherein
the two-dimensional information is a two-dimensional image including luminance information for each pixel;
in the first step, the two-dimensional image is converted into the three-dimensional information by projecting, onto a three-dimensional mesh including a plurality of grid points, the two-dimensional image of which color has been inverted, each of the plurality of grid points including three-dimensional coordinates in the XYZ coordinate system; and
in the second step, a z-directional height of each of the plurality of grid points is determined based on the luminance information;
the height of one of the plurality of grid points that has been determined is offset depending on a spot size of the laser beam;
an area of a light-shielding region is determined based on the height of each of the plurality of grid points that has been offset; and
the projection path data is produced depending on the area of the light-shielding region that has been determined.

5. A method of producing a projection path data to be used in forming a desired shape by projecting a laser beam into a material, the method comprising:
inverting a color of a two-dimensional image representing the desired shape in two dimensions in an XYZ coordinate system;
determining an area of a light-shielding region for each pixel based on luminance information of each pixel of the two-dimensional image; and
determining the projection path depending on the area of the light-shielding region that has been determined.

6. A method of processing inside a material, the method comprising:
forming a desired shape in a material by projecting a laser beam along a projection path represented by a projection path data produced by the production method according to claim 1.

7. A CAM system that produces a projection path data to be used in projecting a laser beam into a material and forming a desired shape, the CAM system comprising:
a processor configured or programmed to produce the projection path data by executing:
a first processing of converting two-dimensional information representing the desired shape in two dimensions in an XYZ coordinate system into three-dimensional information in an XYZ coordinate system; and
a second processing of producing the projection path data based on the three-dimensional information that has been converted.
